(19) United States
(12) Patent Application Publication
(10) Pub. No.: US 2006/0191275 A1
(43) Pub. Date: Aug. 31, 2006

(54) Multi-air conditioner central control system and power control method thereof

(75) Inventors: Jae Sik Jung, Seoul (KR); Sang Chul Youn, Seoul (KR); Duck Gu Jeon, Seoul (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/341,620

(22) Filed: Jan. 30, 2006

(30) Foreign Application Priority Data
Feb. 25, 2005 (JP) 2005-0015932

(51) Int. Cl. F25B 49/00; F25B 1/00; G01M 1/38

(52) U.S. Cl. 62/228.1; 62/230; 700/276

(57) ABSTRACT

Disclosed herein are a multi-air conditioner central control system and a power control method thereof. The central control system comprises a plurality of watt-hour meters for measuring power consumption of a plurality of multi-air conditioners each having an outdoor unit and a plurality of indoor units, to compute power consumption of the respective indoor units, and a central control unit for dividing power consumption of the respective indoor units into operating power consumption and standby power consumption according to operation or non-operation of the respective indoor units and a particular one of the outdoor units connected with the indoor units, and accumulating integral power consumption of the respective indoor units by adding the operating power consumption and standby power consumption thereof. The power control method is adapted to determine whether the respective multi-air conditioners are in operation or not to allocate a larger portion of available power to multi-air conditioners in operation through power redistribution. Thus, power consumption states of the respective multi-air conditioners can be more accurately identified in real time, and power management of the multi-air conditioners can be efficiently performed.

### BACKGROUND OF THE INVENTION

1. Field of the Invention

The present invention relates to a multi-air conditioner central control system and a power control method thereof wherein power consumption received through an outdoor unit to which a plurality of indoor units are connected is divided into standby power consumption and operating power consumption of the indoor units so that non-operating ones of the indoor units do not accumulate the operating power consumption.

2. Description of the Related Art

Recently, air conditioners have entered into such widespread use that they are installed in individual rooms of a home or individual offices of a building.

These air conditioners are mainly divided into two types. One is a single-type air conditioner suitable for air conditioning in a small room, and the other is a multi-air conditioner system which is installed in a large building and requires coordinated management. The single-type air conditioner comprises an indoor unit installed in the room and an outdoor unit installed outside of the room and connected with the indoor unit to circulate a coolant. The single-type air conditioner can be separately controlled for each room.

The multi-air conditioner system comprises a plurality of multi-air conditioners each of which includes an outdoor unit and a plurality of indoor units. The plurality of indoor units installed in rooms of the building can be controlled through controlling means connected with the outdoor unit.

In the multi-air conditioner system, power consumption of the respective indoor units installed in the rooms can be monitored through a separately provided central control unit, and not only states of the indoor units but also states of the outdoor unit distributing the coolant to the indoor units can be easily examined.

In general, a multi-air conditioner system comprises a plurality of multi-air conditioners each of which includes a plurality of indoor units installed in individual rooms of a building for air conditioning and an outdoor unit connected in common with the indoor units to control the flow of a coolant therethrough, and a central control unit for controlling the multi-air conditioners, outdoor units and indoor units in an integrated manner.

To perform power control in the multi-air conditioner system, integral power consumption computed by a particular one of the outdoor units is uniformly divided among the indoor units connected to the particular outdoor unit. This power control approach is disclosed in detail in Korean Patent Application No. 2003-070324.

However, the conventional multi-air conditioner system having the configuration described above evenly divides the integral power consumption computed by the particular outdoor unit among the indoor units to calculate the integral power consumption of the respective indoor units regardless of operation rates thereof. Consequently, there is a problem in that additional power consumption corresponding to the integral power consumption of the particular outdoor unit is allocated to non-operating ones of the indoor units.

### SUMMARY OF THE INVENTION

Accordingly, the present invention has been made in view of the above problems, and it is an object of the present invention to provide a multi-air conditioner central control system and a power control method thereof wherein power consumption of indoor units connected to a particular one of outdoor units is computed to determine whether the respective indoor units are in operation or not, and to allocate a larger portion of available power to operating ones of the indoor units through redistribution of power using results of the determination, thereby enhancing efficiency of a power control operation.

In accordance with an aspect of the present invention, the above and other objects can be accomplished by the provision of a multi-air conditioner central control system comprising: a plurality of watt-hour meters for measuring power consumption of a multi-air conditioner system including a plurality of multi-air conditioners each having an outdoor unit and a plurality of indoor units, to compute power consumption of the respective indoor units; a plurality of power indicators each serving to indicate power consumption measured by an associated one of the watt-hour meters to display power consumption per indoor unit; and a central control unit for analyzing power consumption of the respective multi-air conditioners to reallocate available power to the respective multi-air conditioners.

In accordance with another aspect of the present invention, there is provided a power control method of a multi-air conditioner central control system, comprising the steps of: a) computing power consumption of a particular one of outdoor units and indoor units connected to the particular outdoor unit and sending the computed power consumption to a central control unit; b) determining whether the particular outdoor unit is in operation by comparing the computed power consumption with reference power consumption of the particular outdoor unit, and determining whether the respective indoor units connected to the particular outdoor unit are in operation if the particular outdoor unit is determined to be in operation; and c) allocating available power to operating ones of the indoor units.

In a feature of the present invention, power consumption of a plurality of multi-air conditioners is analyzed to reallocate available power to the respective multi-air conditioners through a central control unit, which is adapted to determine if the respective multi-air conditioners are in operation or not and allocate a larger portion of the available power to operating ones of the multi-air conditioners through power redistribution, and thus power consumption states of the respective multi-air conditioners can be more accurately identified in real time and power management of the multi-air conditioners can be efficiently performed.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the configuration of a multi-air conditioner central control system according to the present invention;

FIG. 2 is a block diagram showing the configuration of a central control unit of the central control system according to the present invention;

FIG. 3 is a block diagram showing the configuration of an integral power control module of the central control unit according to the present invention; and

FIG. 4 is a flow chart illustrating a power control method of the multi-air conditioner central control system according to the present invention.

### DESCRIPTION OF THE PREFERRED EMBODIMENTS

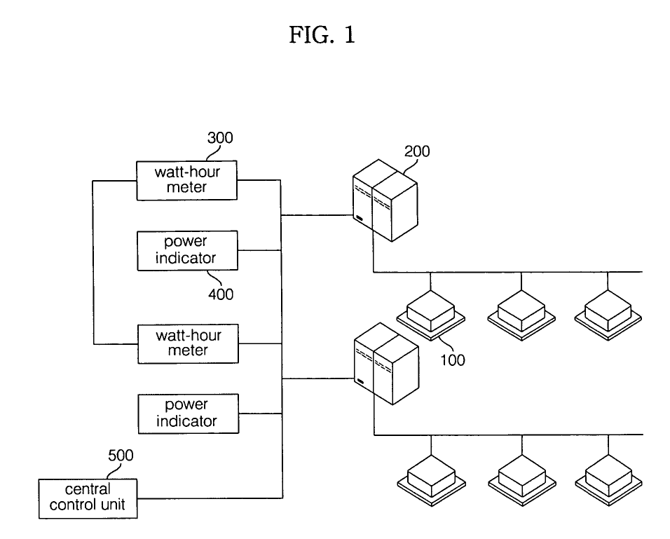

FIG. 1 is a block diagram showing the configuration of a multi-air conditioner central control system according to the present invention.

As shown in FIG. 1, the multi-air conditioner central control system according to the present invention comprises a plurality of multi-air conditioners (100 and 200) each including a plurality of indoor units 100 and an outdoor unit 200 connected in common with the indoor units 100, a plurality of watt-hour meters 300 each for measuring power consumption of a particular one of the outdoor units 200 for a predetermined time to calculate power consumption of the respective indoor units 100.

Each of the watt-hour meters 300 is adapted to measure power consumption of the particular outdoor unit 200, which is the same as the total amount of power consumption of a plurality of indoor units 100 connected to the particular outdoor unit 200.

The multi-air conditioner central control system also comprises a plurality of power indicators 400, each of which displays the power consumption per indoor unit calculated by an associated one of the watt-hour meters 300. The central control system further comprises a central control unit 500 which determines whether the respective indoor units 100 and outdoor units 200 are in operation or not on the basis of the power consumption per indoor unit calculated by the watt-hour meters 300 to control the multi-air conditioners (100 and 200) such that a larger amount of power is allocated to operating ones of the indoor units 100 and outdoor units 200 through redistribution of available power.

The central control unit 500 is connected with the indoor units 100 and outdoor units 200 via a network. Using state information data received from a particular one of the outdoor units 200, the central control unit 500 can monitor a plurality of indoor units 100 connected to the particular outdoor unit 200 and determine whether each of the indoor units 100 is in operation or not.

In addition, the central control unit 500 is connected with the watt-hour meters 300. The central control unit 500 divides the power consumption measured by the watt-hour meters 300 into operating power consumption and standby power consumption according to operation or non-operation of the indoor units 100 and outdoor units 200 to compute unit integral power consumption per indoor unit.

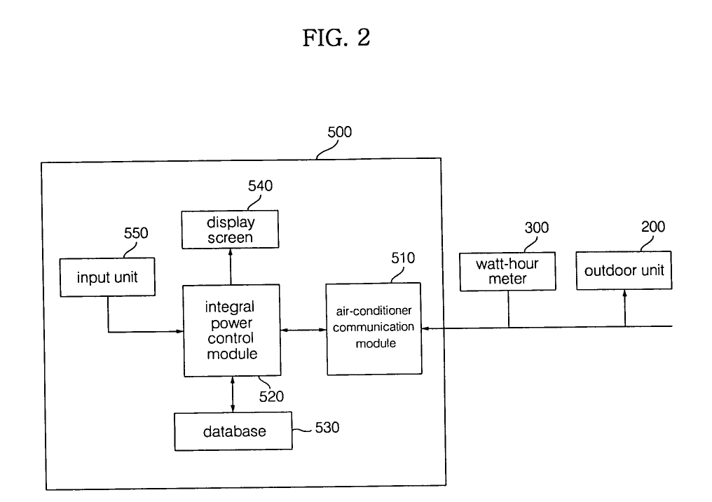

FIG. 2 is a block diagram showing the configuration of the central control unit according to the present invention.

As shown in FIG. 2, the central control unit 500 includes an air-conditioner communication module 510 connected through the network with the indoor units 100 and outdoor units 200 and watt-hour meters 300 for data transmission and reception, and an integral power control module 520 for computing the unit integral power consumption of the respective indoor units 100 using data received via the air-conditioner communication module 510.

The central control unit 500 also includes a database 530 for storing unique information, state information and unit integral power consumption data of the indoor units 100 and outdoor units 200, a display screen 540 for externally outputting the unit integral power consumption or current power consumption per indoor unit computed through the integral power control module 520, and an input unit 550 for inputting external control commands to control operations of the indoor units 100 and outdoor units 200.

The air-conditioner communication module 510 is adapted to periodically monitor the state information data from the indoor units 100 and outdoor units 200, and send power consumption data, indicating the amount of power consumed during a predetermined time in the outdoor units 200, received from the watt-hour meters 300 and state information data received from the outdoor units 200 to the integral power control module 520.

The integral power control module 520 compares the power consumption during the predetermined time in the respective outdoor units 200 with reference power consumption thereof to determine whether the respective outdoor units 200 are in operation or not, and computes integral power consumption of the respective outdoor units 200.

If a particular one of the outdoor units 200 is in operation, the integral power control module 520 determines whether the indoor units 100 connected to the particular outdoor unit 200 are in operation or not using the state information data of the particular outdoor unit 200 to compute the integral power consumption of the respective indoor units 100.

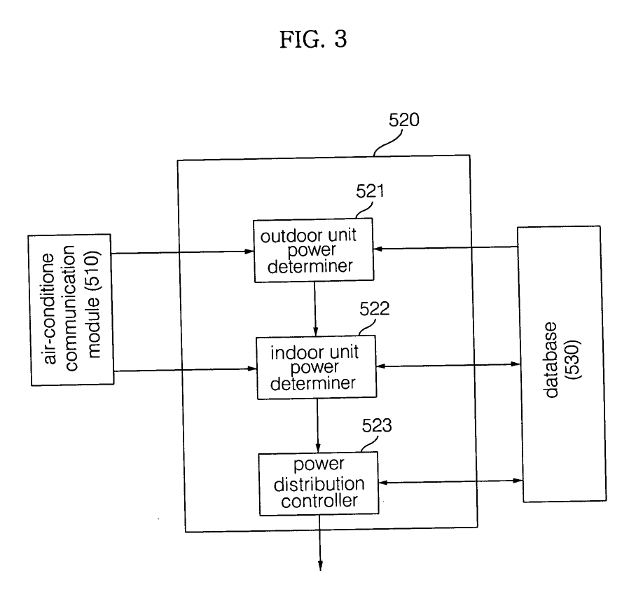

FIG. 3 is a block diagram showing the internal configuration of the integral power control module according to the present invention.

As shown in FIG. 3, the integral power control module 520 includes an outdoor unit power determiner 521 for determining whether the particular outdoor unit 200 is in operation or not using power consumption data from one of the watt-hour meters 300 connected with the particular outdoor unit 200, and an indoor unit power determiner 522 for determining whether respective indoor units 100 connected to the particular outdoor unit 200 which has been determined to be in operation by the outdoor unit power determiner 521 are in operation or not.

The integral power control module 520 also includes a power distribution controller 523 for deriving either operating power consumption of a specific one of the indoor units 100 if the specific indoor unit 100 has been determined to be in operation by the indoor unit power determiner 522 or standby power consumption of the specific indoor unit 100 if it has been determined not to be in operation, and allocating the derived operating power consumption or standby power consumption to the specific indoor unit 100 to compute unit integral power consumption of the specific indoor unit 100.

The outdoor unit power determiner 521 determines whether the particular outdoor unit 200 is in operation or not, using the power consumption of the particular outdoor unit 200 received from the associated watt-hour meter 300.

Namely, if none of a plurality of indoor units 100 connected to the particular outdoor unit 200 are in operation, the particular outdoor unit 200 is not in operation either, consuming only a specific amount of standby power. Thus, if the power consumption of the associated watt-hour meter 300 connected with the particular outdoor unit 200 is less than or equal to a predetermined amount of power corresponding to the standby power consumption, it can be determined that the particular outdoor unit 200 is not in operation.

Consequently, the unit integral power consumption of each of the respective indoor units 100 connected to the particular outdoor unit 200 which is not in operation is computed by dividing the power consumption of the particular outdoor unit 200 by the number of the indoor units 100 connected to the particular outdoor unit 200.

At this time, the standby power consumption of the particular outdoor unit 200 can be varied according to the capacity thereof and the like, and can be set through unique information data thereof.

The indoor unit power determiner 522 determines whether indoor units 100 connected to only the particular outdoor unit 200 which has been determined to be in operation by the outdoor unit power determiner 521 are in operation or not. Whether a specific one of the indoor units 100 is in operation or not can be determined through extracting only state information regarding the specific indoor unit 100 from various information contained in the state information data sent from the particular outdoor unit 200.

The power distribution controller 523 can compute the unit integral power consumption of the respective indoor units 100 which are either in operation or not in operation, on the basis of the determination of the indoor unit power determiner 522.

A procedure to compute the unit integral power consumption will be described in detail. According to determination of the outdoor unit power determiner 521, if the particular outdoor unit 200 is not in operation, none of the indoor units 100 connected to the particular outdoor unit 200 is in operation either. Hence, for a specific one of the indoor units 100 not in operation, the unit integral power consumption is given by adding the value obtained through dividing the power consumption of the particular outdoor unit 200 by the number of the indoor units 100 connected to the particular outdoor unit 200 to previous unit integral power consumption. Here, the value obtained by dividing the amount of power consumption of the particular outdoor unit 200 by the number of the indoor units can be estimated to be the standby power consumption of the specific indoor unit 100.

On the other hand, if any of the indoor units 100 connected to the particular outdoor unit 200 is in operation, the particular outdoor unit 200 is in operation. Hence, each of the indoor units 100 must be determined to be in operation or not. For a specific one of the indoor units 100 not in operation, the standby power consumption thereof is set to the standby power consumption estimated as above. For a specific one of the indoor units 100 in operation, the operating power consumption can be computed through multiplying the power consumption of the particular outdoor unit 200 by the ratio of an operation rate of the specific indoor unit 100 to the sum of operation rates of the respective indoor units 100 in operation.

The unit integral power consumption of the specific indoor unit 100 is given by adding the computed operating power consumption and standby power consumption to the previous unit integral power consumption depending upon operation or non-operation of the specific indoor unit 100.

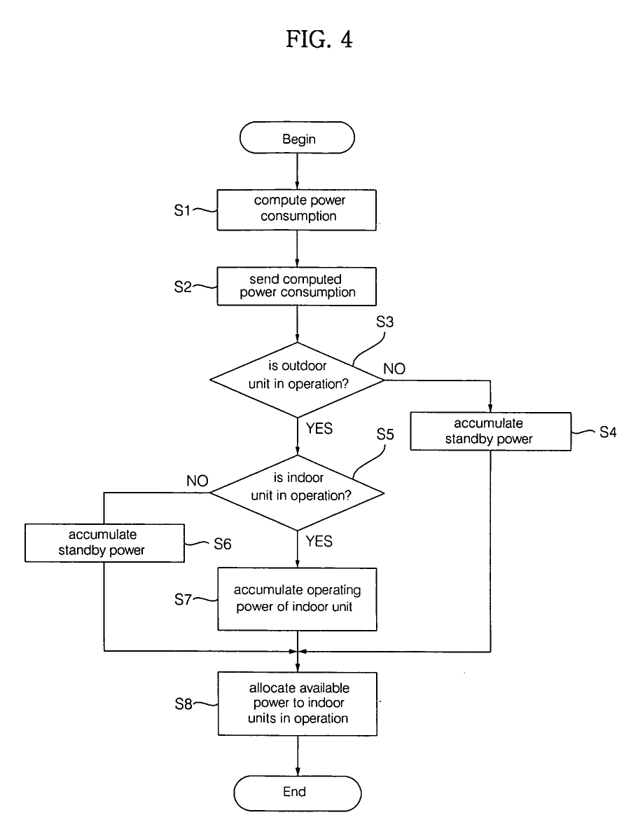

FIG. 4 is a flow chart illustrating a power control method of the multi-air conditioner central control system according to the present invention.

Firstly, a particular one of the watt-hour meters connected to a particular one of the outdoor units computes power consumption of the particular outdoor unit and indoor units connected to the particular outdoor unit (S1).

The particular watt-hour meter sends the computed power consumption to the central control unit (S2).

The computed power consumption of the particular outdoor unit is compared with the standby power consumption thereof. If the computed power consumption is greater than the standby power consumption, the particular outdoor unit is determined to be in operation (S3).

If the particular outdoor unit is determined to be not in operation, the computed power consumption of the particular outdoor unit is accumulated to the standby power consumption thereof (S4).

On the other hand, if the particular outdoor unit is determined to be in operation, the computed power consumption and standby power consumption of a specific one of the indoor units connected to the particular outdoor unit are compared. If the computed power consumption is greater than the standby power consumption, the specific indoor unit is determined to be in operation (S5).

If the specific indoor unit is determined not to be in operation, the computed power consumption of the specific indoor unit is added to the standby power consumption thereof (S6). If the specific indoor unit is determined to be in operation, the computed power consumption thereof is added to the operating power consumption of the specific indoor unit (S7).

Afterwards, in distribution of available power of the entire air conditioner system to the outdoor units, a larger portion of the available power is allocated to outdoor units in operation in comparison to remaining ones not in operation, using data regarding the accumulated standby power consumption and accumulated operating power consumption. In addition, in distribution of available power in the outdoor units in operation, a larger portion of power is allocated to indoor units in operation in comparison to remaining ones not in operation (S8).

After a predetermined time, the steps described above are repeated for efficient redistribution of available electric power.

As apparent from the above description, the present invention provides a multi-air conditioner central control system and a power control method thereof. The multi-air conditioner central control system comprises a central control unit for monitoring power consumption of a plurality of multi-air conditioners and redistributing available power to the multi-air conditioners. The power control method is adapted to determine whether the respective multi-air conditioners are in operation or not to allocate a larger portion of the available power to multi-air conditioners in operation through power redistribution. Thus, power consumption states of the respective multi-air conditioners can be more accurately identified in real time, and power management of the multi-air conditioners can be efficiently performed.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A multi-air conditioner central control system, comprising:
a plurality of watt-hour meters for measuring power consumption of a multi-air conditioner system including a plurality of multi-air conditioners each having an outdoor unit and a plurality of indoor units, to compute power consumption of the respective indoor units; and
a central control unit for dividing power consumption of the respective indoor units into operating power consumption and standby power consumption according to operation or non-operation of the respective indoor units and a particular one of the outdoor units connected with the indoor units, and accumulating integral power consumption of the respective indoor units by adding the operating power consumption and standby power consumption thereof.

2. The multi-air conditioner central control system as set forth in claim 1, further comprising a plurality of power indicators each for serving to readout power consumption measured by an associated one of the watt-hour meters to display power consumption per indoor unit.

3. The multi-air conditioner central control system as set forth in claim 1, wherein the central control unit includes:
an air-conditioner communication module for sending/receiving data to/from the outdoor units and the watt-hour meters; and
an integral power control module for utilizing power consumption of the particular outdoor unit during a predetermined time to compute unit integral power consumption of the respective indoor units connected to the particular outdoor unit.

4. The multi-air conditioner central control system as set forth in claim 3, wherein the central control unit further includes a database for storing the unit integral power consumption computed by the integral power control module.

5. The multi-air conditioner central control system as set forth in claim 3, wherein the integral power control module includes a power distribution controller for separately computing operating power consumption and standby power consumption of the respective indoor units according to operation or non-operation of the respective indoor units and the particular outdoor unit, and accumulating the unit integral power consumption of the respective indoor units by adding the computed operating power consumption and standby power consumption thereof.

6. The multi-air conditioner central control system as set forth in claim 5, wherein the integral power control module includes:
an outdoor unit power determiner for determining whether the particular outdoor unit is in operation or not using power consumption of the particular outdoor unit; and
an indoor unit power determiner for determining whether the indoor units connected to the particular outdoor unit which has been determined to be in operation by the outdoor unit power determiner are in operation or not using state information data from the particular outdoor unit.

7. The multi-air conditioner central control system as set forth in claim 6, wherein the outdoor unit power determiner compares integral power consumption of the particular outdoor unit received from a particular one of the watt-hour meters connected to the particular outdoor unit with reference power consumption set in advance, and determines that the particular outdoor unit is in operation if the integral power consumption is greater than the reference power consumption.

8. The multi-air conditioner central control system as set forth in claim 7, wherein the power distribution controller, if the particular outdoor unit is not in operation, divides the integral power consumption of the particular outdoor unit by the number of the indoor units connected to the particular outdoor unit to compute standby power consumption of each of the indoor units.

9. The multi-air conditioner central control system as set forth in claim 7, wherein the power distribution controller, if the particular outdoor unit is in operation, computes operating power consumption of a selected one of the respective indoor units connected to the particular outdoor unit by multiplying the integral power consumption of the particular outdoor unit by a ratio of an operation rate of the selected indoor unit to a sum of operation rates of the respective indoor units.

10. A power control method of a multi-air conditioner central control system, comprising the steps of:
a) sensing power consumption of a particular one of outdoor units;
b) determining if the particular outdoor unit and a plurality of indoor units connected to the particular outdoor unit are in operation using the sensed power consumption and state information data from the particular outdoor unit; and
c) separately computing operating power consumption and standby power consumption of the respective indoor units according to results of the step b), and accumulating unit integral power consumption of the respective indoor units by adding the computed operating power consumption and standby power consumption thereof.

11. The power control method as set forth in claim 10, wherein the step a) includes the steps of:
a-1) measuring the power consumption of the particular outdoor unit by a particular one of watt-hour meters connected to the particular outdoor unit; and
a-2) sending the measured power consumption to a central control unit.

12. The power control method as set forth in claim 10, wherein the step b) includes the steps of:
b-1) comparing the power consumption of the particular outdoor unit sensed at the step a) with reference power consumption and determining that the particular outdoor unit is in operation if the power consumption thereof is greater than the reference power consumption; and
b-2) receiving, if the particular outdoor unit is determined to be in operation, state information data from the particular outdoor unit and determining if the respective indoor units connected to the particular outdoor unit are in operation.

13. The power control method as set forth in claim 12, wherein the step c) includes the step of computing, if the particular outdoor unit is determined to be not in operation at the step b-1), the standby power consumption of each of the indoor units by dividing the power consumption of the particular outdoor unit by the number of the indoor units connected to the particular outdoor unit.

14. The power control method as set forth in claim 13, wherein the step c) further includes the step of computing, if the particular outdoor unit is determined to be in operation at the step b-1), the operating power consumption of a selected one of the respective indoor units connected to the particular outdoor unit by multiplying the power consumption of the particular outdoor unit by a ratio of an operation rate of the selected indoor unit to a sum of operation rates of the respective indoor units, and accumulating the unit integral power consumption of the respective indoor units by adding the computed operating power consumption and standby power consumption thereof.
